(19) United States
(12) Patent Application Publication
(10) Pub. No.: US 2026/0289893 A1
(43) Pub. Date: Sep. 24, 2026

(54) HARDWARE-VERSION-BASED TASK EXECUTION

(71) Applicant: Advanced Micro Devices, Inc., Santa Clara, CA (US)

(72) Inventors: Yue Zhuo, Shanghai (CN); Zhen Hu, Shanghai (CN)

(73) Assignee: Advanced Micro Devices, Inc., Santa Clara, CA (US)

(21) Appl. No.: 19/085,692

(22) Filed: Mar. 20, 2025

(51) Int. Cl. G06T 15/00; G06T 15/06

(52) U.S. Cl. CPC G06T 15/005; G06T 15/06

(57) ABSTRACT

Techniques are provided herein to provide a customized set of shader programs for different hardware versions for ray tracing hardware. Each such shader program varies in terms of what local state is stored. In particular, each shader program is tailored such that its associated set of local state does not exceed the amount actually needed by the corresponding hardware version. This customization of shader programs helps to reduce the amount of resources utilized by the shader programs, as compared with a situation in which a single “monolithic” shader program checked the hardware version at runtime, as such a monolithic shader program would need to reserve the maximum amount of resources for any possible hardware version.

### BACKGROUND

In image synthesis, ray tracing is utilized to find a nearest intersection of a given ray with a scene where light propagation is simulated. Ray tracing is a complex technique that is highly computationally intensive, and improvements to make ray tracing calculations more efficient are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 illustrates a system by which ray tracing work is performed on an accelerated processing device (“APD”), according to an example;

FIG. 6 illustrates an example operation whereby a shader program requests a task to be performed;

FIG. 7A is a diagram illustrating generation of different shader programs for different hardware versions, according to an example;

FIG. 7B illustrates loading tasks for execution, where the task that is loaded is dependent on a hardware version;

FIG. 8 illustrates an example of execution of a shader program according to a particular hardware version; and

FIG. 9 is a flow diagram of a method for executing ray tracing tasks, according to an example.

### DETAILED DESCRIPTION

Ray tracing is a technique whereby virtual light rays are traced through a scene to render the geometry of the scene. Hardware acceleration for ray tracing provides improved performance as compared with purely software techniques. Ray tracing workloads typically involve execution of a number of shader programs, some of which are completely defined by an application, and others of which are provided by and defined by a device driver.

The device driver is typically written to support multiple versions of ray tracing hardware. The shader programs defined by the device driver may thus have varying operations or capabilities depending on the hardware version. In particular, shader programs are required to maintain a data structure that stores certain state for ongoing ray tracing operations. This can be, for example, state defining a ray (e.g., ray origin and direction) as well as state describing the progress through bounding volume hierarchy traversal. The state required to be maintained by these shader programs may vary by hardware version.

Techniques are provided herein to provide a customized set of shader programs for different hardware versions. Each such shader program varies in terms of what local state is stored. In particular, each shader program is tailored such that its associated set of local state does not exceed the amount actually needed by the corresponding hardware version. This customization of shader programs helps to reduce the amount of resources utilized by the shader programs, as compared with a situation in which a single “monolithic” shader program checked the hardware version at runtime, as such a monolithic shader program would need to reserve the maximum amount of resources for any possible hardware version.

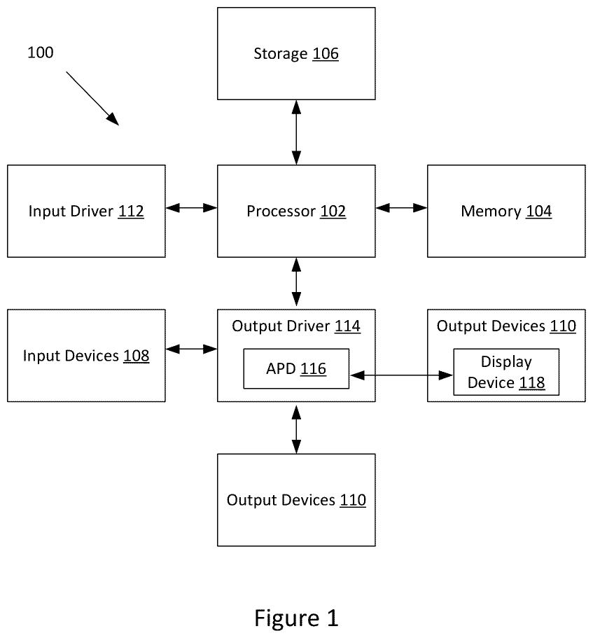

FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a parallel processing paradigm, such as a single-instruction-multiple-data (“SIMD”) paradigm or a single-instruction-multiple-threads (“SIMT”). Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a parallel processing paradigm may perform the functionality described herein. Alternatively, it is contemplated that computing systems that do not perform processing tasks in accordance with a parallel processing paradigm can also perform the functionality described herein. The APD 116 includes APD memory 139, which is available for the compute units 132, and local data share memory 137, which is local to each compute unit 132 and is available to its respective compute unit 132.

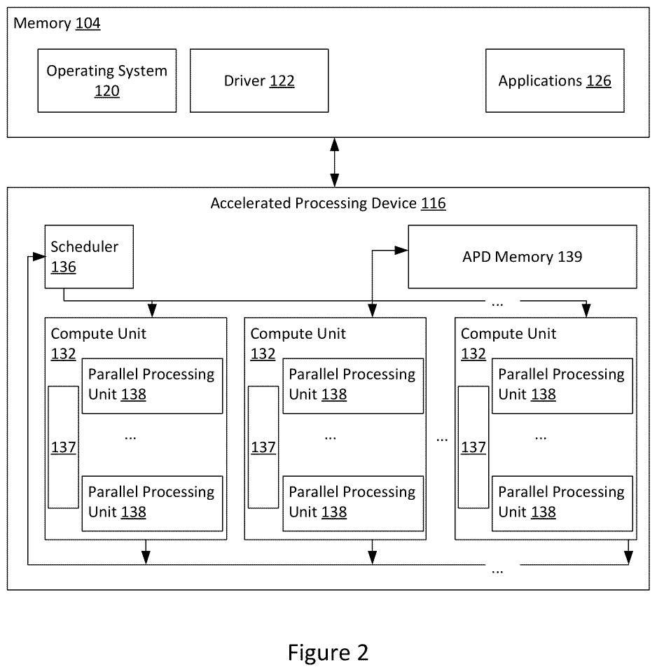

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the parallel processing units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more parallel processing unit 138 that perform operations at the request of the processor 102 in a parallel manner according to a parallel processing paradigm, such as SIMD or SIMT. In such paradigms, multiple processing elements execute the same instruction across multiple data elements or threads. The multiple processing elements share a single program control flow unit and program counter and thus execute the same program but are able to execute that program with or using different data. In one example, each parallel processing unit 138 includes sixteen lanes, where each lane executes the same instruction at the same time as the other lanes in the parallel processing unit138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program or kernel that is to be executed in parallel according to the parallel processing paradigm employed. For example, in a SIMD architecture, multiple work-items execute the same instruction simultaneously on different data elements. Work-items can be executed simultaneously as a “wavefront” on a parallel processing unit 138, where each work-item executes the same instruction with different data and where different work-items can execute a different control flow path through the use of predication. In a SIMT architecture, work-items correspond to threads that can be executed simultaneously on the parallel processing unit 138, where different threads can execute different control flow paths. Threads are grouped into “warps” or “wavefronts”, which are scheduled or executed together.

For the purposes of this description, the term “wavefront” will be used, but it should be understood that this term broadly describes work-items that can be executed simultaneously and is inclusive of both “wavefronts” and “warps.” One or more wavefronts are included in a “work group,” which includes a collection of work-items designated to execute the same program. A work group can be executed by executing each of the wavefronts that make up the work group. In alternatives, the wavefronts are executed sequentially on a single parallel processing unit 138 or partially or fully in parallel on different parallel processing unit 138. Wavefronts can be thought of as the largest collection of work-items that can be executed simultaneously on a single parallel processing unit 138. Thus, if commands received from the processor 102 indicate that a particular program is to be parallelized to such a degree that the program cannot execute on a single parallel processing unit 138 simultaneously, then that program is broken up into wavefronts which are parallelized on two or more parallel processing units 138 or serialized on the same parallel processing unit 138 (or both parallelized and serialized as needed). A scheduler 136 performs operations related to scheduling various wavefronts on different compute units 132 and parallel processing units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

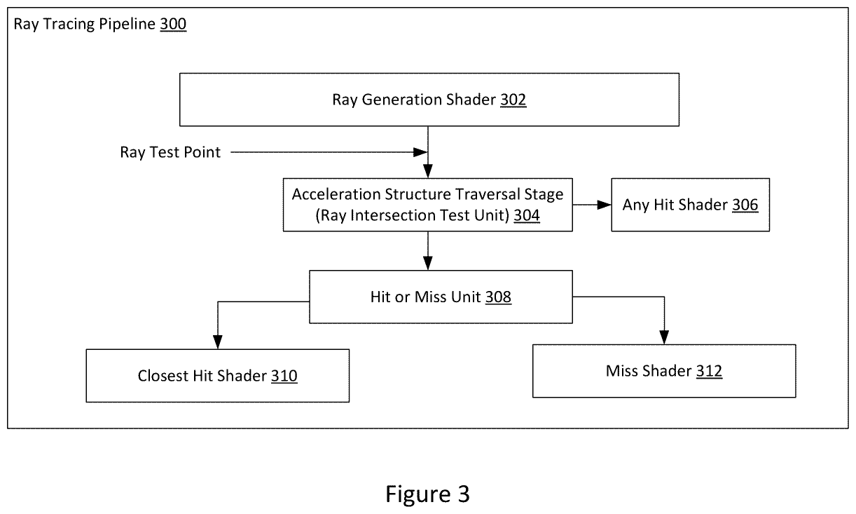

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

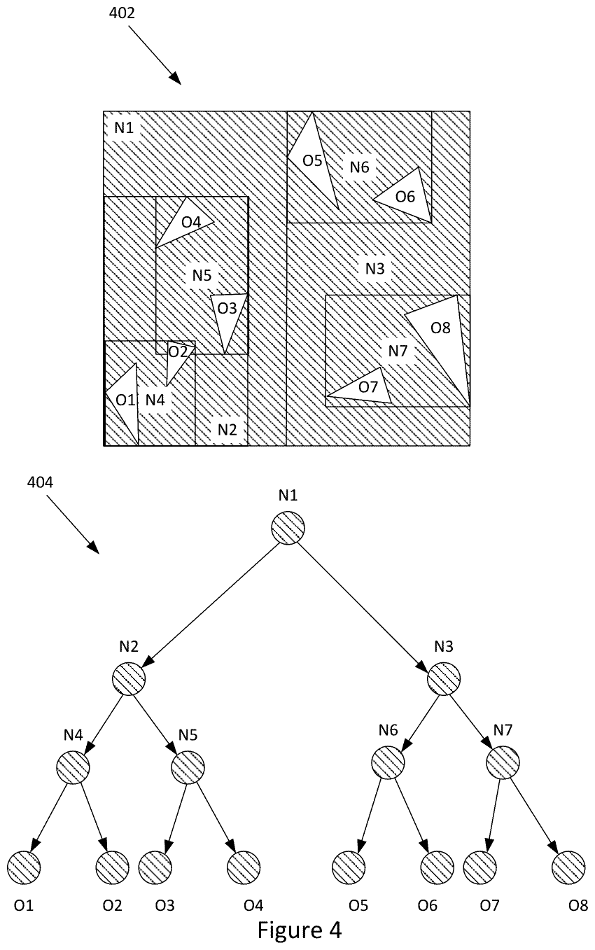

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated on the topside of FIG. 4 and the tree representation 404 of the bounding volume hierarchy is illustrated on the bottom side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the test for that non-leaf node fails. In an example, the ray intersects O₅ but no other triangle. The test would test against N₁, determining that that test succeeds. The test would test against N₂, determining that the test fails (since O₅ is not within N₂). The test would eliminate all sub-nodes of N₂ and would test against N₃, noting that that test succeeds. The test would test N₆ and N₇, noting that N₆ succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

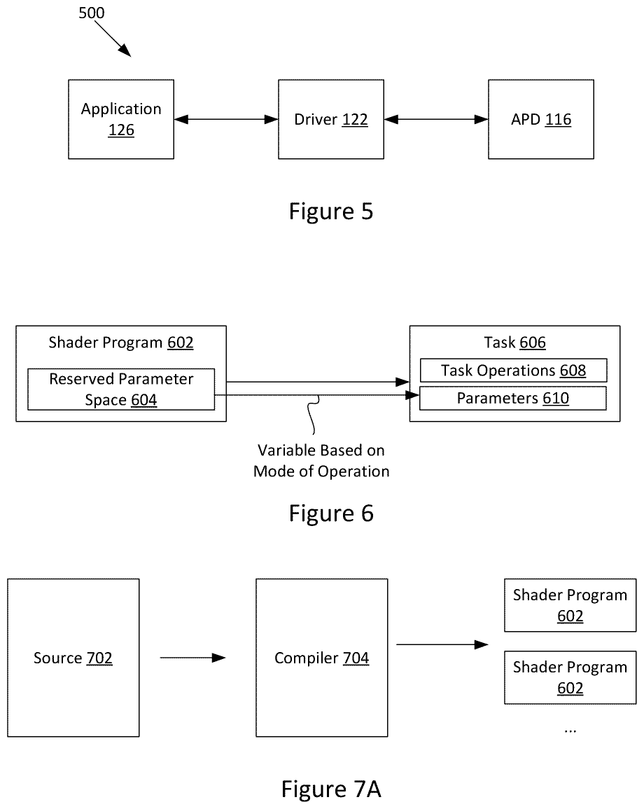

FIG. 5 illustrates a system 500 by which ray tracing work is performed on an APD 116, according to an example. In some examples, an application generates sequences of tasks to be performed by the APD 116 and transmits such sequences of tasks to the driver 122 which provides corresponding commands to the APD 116. Examples of tasks provided by the application 126 include tasks to build a bounding volume hierarchy based on a set of geometry, tasks to generate a ray for traversal of a BVH, or tasks to traverse a BVH for a ray. In some examples, the tasks specify shader programs to execute. In some examples, these tasks directly invoke shader programs that are part of the driver 122. In other examples, the tasks are application-provided shader programs that, themselves, invoke shader programs that are part of the driver.

The driver 122 supports execution of such shader programs in several different modes of operation. In some examples, these modes of operation correspond to different hardware versions. More specifically, there may be several different hardware versions for the hardware of the APD 116. The driver 122 may be developed from a single code base that can adapt to different APD hardware versions. In particular, the requests to execute shader programs, as specified by the application 126, may need to be conditioned by the driver 122 in a particular way based on the architecture version of the APD 116. In one example, it is possible for the shader program to accept an input variable that represents the hardware version. At appropriate times during execution, the shader program checks this variable and performs operations accordingly. One aspect that can vary according to hardware version is a data structure that is stored into local registers (or other local storage) in a parallel processing unit 138. In various examples, the information in the data structure includes information about a ray for which operations are to be performed, where this information includes information specifying the ray (e.g., an identifier as well as origin and direction, and “tmin,” specifying the closest point to the origin for which hits can occur and “tmax,” specifying the farthest point to the origin for which hits can occur), the bounding volume hierarchy identifying which bounding volume hierarchy is to be traversed, and, in some instances, traversal state. The traversal state is used for tasks launched for rays that are in the course of traversal. For instance, it is possible to pause traversal for a variety of reasons, such as to perform shader work (e.g., an any hit shader).

In particular, shader programs store information into a local data structure for use. In an example, usage of this information includes requesting hardware to perform certain operations. In an example, such operations include resuming traversal of a BVH after a pause from such traversal. In an example, a shader program requests to resuming traversal after work is performed. In an example, traversal hardware performs traversal operations and then requests a shader program to perform work such as an any hit shader. The shader program executes work for the any hit shader and then requests to resume traversal of the BVH. In some modes of operation, the request to perform this task specifies the traversal state for the ray, and this traversal state is stored in a local data storage reserved by the shader program. In this example, the “traversal state” means information indicating progress through traversal of the BVH for the ray. BVH traversal means traversing a BVH for a ray, which results in identification of one or more hits (or zero if no hits occur), and subsequent execution of appropriate shader programs such as closest hit shaders, any hit shaders, miss shaders, or other shader programs. In some examples, the progress through traversal is represented with a stack or other data structure that stores BVH nodes to be traversed to. More specifically, in an example, traversal through the BVH occurs in a loop. In each iteration of the loop, the BVH traversal obtains one or more nodes from the stack and tests the ray for intersection with such one or more nodes. If one or more of such nodes is a non-leaf node, then if the ray intersects that node, the BVH traversal places the children of that non-leaf node into the stack. Initial contents of the stack include a root node, and traversal is finished when the stack is empty.

As can be seen, the contents of the stack represent the traversal state for traversal of a ray. In some versions of the APD 116 hardware, a request to perform this task—that is, resume traversal of a BVH—includes this traversal state (e.g., the shader program passes this state to the traversal hardware), and in other examples, the traversal hardware maintains the traversal state in a specific location and thus the request to perform the task does not need to independently include such traversal state information.

As can be seen, shader programs performed on an APD 116 store local data, and the contents of that local data varies by hardware version. For example, one hardware version may require local data to store BVH traversal state while another hardware version does not require such data to be stored.

It is possible to implement this variation based on hardware version using a local variable checked by a shader program. In particular, a shader program checks a variable indicating hardware version at runtime in order to determine how to use the local data. In some examples, such shader programs store such parameters for tasks in a local location such as in registers (e.g., vector general purpose registers (“VGPRs”)). Thus, if such a shader program would need to be able to provide such parameters for any version, then that shader program would need to be configured to reserve the maximum number of registers (or other storage space for parameter information) that any version could need. For example, if a first hardware version requires a first amount of parameter data and a second hardware version requires a smaller amount of parameter data, then regardless of which version of the hardware is indicated as being used at runtime, the shader program needs to reserve storage for the higher amount of parameter data. In an example, in terms of the source code from which such a shader program would be compiled, that source code would still need to declare storage space (e.g., a variable such as a C struct) to hold the largest amount of data. At runtime, the shader program would check that storage space and interpret it differently depending on version type (e.g., using a C struct union). However, even if a smaller amount of data is used due for a particular hardware version, the larger amount of data would still need to be reserved.

FIG. 6 illustrates an example operation whereby a shader program 602 utilizes local data by requesting a task 606 to be performed. In the example, the shader program 602, which has a reserved parameter space 604 (an example of the local data), requests a task 606 to be performed. The task 606 specifies task operations 608 (for example, BVH traversal or BVH traversal resume), and the task 606 also includes parameters 610. The shader program 602 includes these parameters 610 from the reserved parameter space 604. The parameters 610 that are provided as part of the task 606 are variable depending on the mode of operation (e.g., dependent on the hardware version).

As can be seen, in one mode of operation, the shader program 602 selects the parameters based on a hardware version variable. However, this is inefficient, since some of the reserved parameter space 604 is not used in some hardware versions. Thus, instead of using a single shader program 602 for each hardware version that checks which hardware version is being used, techniques are provided herein whereby multiple versions of the shader program 602 are compiled. Each such compiled shader program is configured for a particular hardware version. Further, the reserved parameter space 604 in each such compiled shader program is sized for the data needed for the corresponding hardware version.

In some examples, where a first hardware version requires a first amount of reserved parameter space 604 and a second hardware version requires a second, larger amount of reserved parameter space 604, a first version of the shader program 602 has a first amount of reserved parameter space 604 equal to (and not more than) the amount required for the first hardware version and a second version of the shader program 602 has a second amount of reserved parameter space 604 equal to (and not more than) the amount required for the second hardware version.

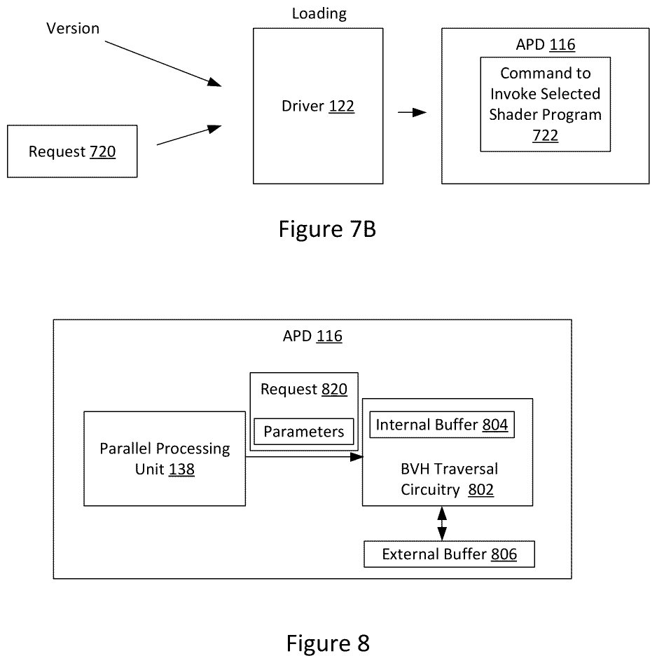

FIG. 7A is a diagram illustrating generation of different shader programs 602 for different hardware versions, according to an example. The compiler 704 accepts source code 702 and generates a plurality of shader programs 602. The source code 702 includes a specification of a reserved parameter space 604 (which is an example of the local storage or local data structure described above). This specification indicates different reserved parameter spaces 604 for different hardware versions.

In an example, the specification of a reserved parameter space 604 indicates a certain reserved parameter space 604 for a first hardware version, and a second reserved parameter space 604 for a second hardware version, where the amount of data in each reserved parameter space 604 differs. The compiler 704 generates multiple shader programs 602. Each shader program 602 is for a different hardware version. Further, each shader program 602 has a different reserved parameter space 604 as specified by the specification of the reserved parameter space 604. Thus, when executed on the APD 116, a particular shader program 602 reserves the resources (e.g., registers and/or local memory) for a more custom-tailored reserved parameter space 604, and not for the largest amount of reserved parameter space 604.

In an example, if a first shader program 602 includes a first specification for a first amount of reserved parameter space 604, then the first shader program 602, when executed, reserves that amount and not more than that amount. A second shader program 602 that includes a second specification for a second, larger amount of reserved parameter space 604 results, when executed, in a second amount being reserved, and not more than that second amount. As the first shader program 602 requires a smaller amount of reserved parameter space 604, the total amount of reserved space occupied by reserved parameters for that program is less than if a single shader program that selected between hardware versions were used.

In some examples, the source 702 is written in a language that includes preprocessor directives. These preprocessor directives are directives to the compiler 704 regarding which portions of the source 702 to include in the resulting compiled shader program 602. In some examples, the compiler 704 compiles the source 702 for each of a set of hardware versions. For each hardware version, the preprocessor directives are provided with a variable that specifies the hardware version being compiled for. The compiler 704 thus includes the instructions as specified according to the preprocessor directives and the variable indicating the hardware version. It should be understood that the reserved parameter space 604 is an example of data stored within the local data structure described elsewhere herein.

FIG. 7B illustrates loading a shader program for execution, where the shader program that is loaded is dependent on a hardware version. In the example illustrated, an application specifies a hardware version number and one or more requests 720. The request 720 and version number cause the driver 122 to invoke a selected shader program 722. In some examples, the application 126 provides a series of commands that includes the request 720. The driver 122 obtains this series of commands and translates these commands into APD commands for execution on the APD 116 and transmits the translated commands to the APD 116 for execution, which the APD 116 then executes. This series of commands includes the request 720 and based on the version number, the driver 122 selects a particular shader program compiled as in FIG. 7A and transmits a command 722 to invoke that selected shader program. The selected shader program is selected based on the version, and reserves an amount of resources based on the version as described elsewhere herein.

FIG. 8 illustrates an example of execution of a shader program according to a particular hardware version. In this example, a parallel processing unit 138 executes a shader program. The shader program includes an instruction to request BVH traversal circuitry 802 to perform an operation (a request 820). The request 820 includes parameters. The request 820 also includes a command for the BVH traversal circuitry 802 to resume traversal of a BVH for a ray. The BVH traversal circuitry includes digital circuitry configured to traverse the BVH, as described elsewhere herein.

In one version of the BVH traversal circuitry 802, when the BVH traversal circuitry 802 pauses traversal of a BVH for a ray, the BVH traversal circuitry 802 stores traversal state for that ray into a memory such as an internal buffer 804 of the BVH traversal circuitry 802 or into an external buffer 806 of the BVH traversal circuitry 802 (where the external buffer 806 can be in any location such as in a memory of the APD 116 or in the memory 104). In such a version, the request 820 does not need to pass, as parameters, that traversal state to the BVH traversal circuitry 802 when the parallel processing unit 138 requests resumption of traversal of the BVH (e.g., after mid-traversal work such as an any hit shader is complete).

In another version of the hardware, the BVH traversal circuitry 802 is not capable of storing the BVH traversal state into an internal buffer 804 or external buffer 806. In that version, the BVH traversal circuitry 802 provides that traversal state to the parallel processing unit 138 for storage while the parallel processing unit 138 performs mid-traversal work (e.g., executes a shader program such as an any hit shader program). Then, when the parallel processing unit 138 transmits the request 820 to resume traversal of the BVH, the parameters of that task request include the traversal state for the BVH traversal circuitry 802 to use. As can be seen, in this example, the parameters specified by requests 820 depend on the capabilities of the hardware. Because these parameters are stored in resources for the parallel processing unit 138 (e.g., registers or local memory), hardware that does not require certain parameters to be passed in with a request 820 results in a smaller number of local resources needing to be reserved by the shader program executing on the parallel processing unit 138 (where this shader program is the entity that generates the request 820).

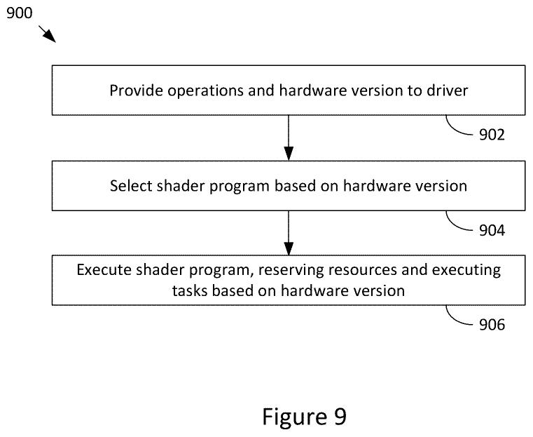

FIG. 9 is a flow diagram of a method 900 for executing ray tracing tasks, according to an example. Although described with respect to the system of FIGS. 1-8, those of skill in the art will understand that any system configured to perform the steps of the method 900 in any technically feasible order falls within the scope of the present disclosure.

At step 902, the application 126 provides operations and a hardware version to a driver 122. The operations include requests to execute shader programs based on the hardware version. More particularly, the driver 122 has access to multiple versions of shader programs, each compiled for a different hardware version. In part, these different versions vary based on how these versions request hardware of the APD 116 to perform certain tasks specified by the operations provided by the application 126. More particularly, these tasks specify operations to be performed by the hardware, where the operations utilize certain parameters passed to the hardware by the shader program. The specific parameters that are used by these tasks varies based on the hardware version. For example, in some hardware versions, certain types of data such as BVH traversal state must be passed as a parameter in a task while in other versions, passing such data is not necessary. The shader programs reserve space for such parameters locally so that the shader programs can pass such parameters to such tasks when the shader programs request the tasks to be executed.

At step 904, the driver 122 selects a particular shader program based on the hardware version. As described above, each different shader program uses a different set of reserved space for local parameters, and this set is based on the hardware version.

At step 906, the driver 122 executes the shader program selected at step 904. Execution of this shader program includes reserving the resources (e.g., registers and/or local memory) required by the specified set of reserved space for local parameters.

Execution in this manner, with selection of shader program based on resources required, allows for a reduction in reserved resources in certain situations, as compared with a situation in which a single “monolithic” shader program for all hardware versions is used. In particular, such a monolithic shader program would need to reserve enough local resources for the largest amount of space needed by an version, meaning that versions that use less than this amount of space would nevertheless need to reserve the higher amount of space. Selecting a shader program based on the version prevents this inefficient use, as the selected shader program reserves not more than the amount of resources actually needed for that hardware version.

In various examples, the selected shader program is executed and performs its designated operation. The shader programs include various ray tracing operations, such as operations to build a bounding volume hierarchy and operations to traverse a BVH (for example, operations for requesting BVH traversal circuitry 802 to perform such traversal as well as other operations such as operations to launch work that is to be performed as the result of such traversal, such as executing an any hit shader or other shader). The application 126 launches ray tracing work to be performed on the APD 116 by specifying sequences of such shader programs as well as input data to be processed by such shader programs, and the application 126 can also include other shader programs not discussed herein, but that work in conjunction with the shader programs described above and form part of an overall ray tracing workload. It is stated above that the shader programs that are compiled into different versions and selected based on version are directly specified by the application 126 but it is also possible for there to be a degree of indirection. In particular, it is possible for shader programs specified by the application 126 to, themselves, call shader programs for which there are different versions corresponding to different hardware versions. In other words, it is possible that a shader program generated by the application 126 (as opposed to being included within the driver 122) invokes a different shader program that is included within the driver 122. In some examples, the invocation of this shader program within a different shader program is, itself, configured to invoke the shader program determined by the hardware version. In some examples, this invocation is performed by the driver 122 during compilation. In other words, the application 126 submits its own shader program for compilation as well as a hardware version. The shader program invokes another shader program for which the driver 122 stores multiple versions dependent on hardware version. The driver 122 compiles the application-supplied shader program to invoke a specific driver-side shader program based on the hardware version.

Above, it is described that the application 126 provides the hardware version to the driver 122. The application can provide the hardware version each time the application 126 specifies a shader program that can vary based on hardware version. Alternatively, the application can provide the hardware version once upon application startup and the driver 122 then uses that hardware version each time the application 126 specifies a shader program that can vary based on hardware version for execution. In yet other examples, the driver 122 obtains the hardware version not from the application 126 but from the APD 116 itself, for example when the driver 122 is installed.

It should be understood that execution of the shader programs selected and executed as described above leads to rendering results such as pixel colors being set in an image buffer (and, for example, subsequently displayed to a display device). For example, BVH traversal results in shader execution such as closest hit shader or any hit shader execution, and these shaders can result in setting a pixel color for pixels of an image. Thus execution of a very large number of shader programs can result in rendering of an image.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the compute units 132, the parallel processing units 138, the ray tracing pipeline 300, including the ray generation shader 302, acceleration structure traversal stage 304, any hit shader 306, hit or miss unit 308, closest hit shader 310, the miss shader 312, or the BVH traversal circuitry 802 may be implemented as a general purpose computer, a processor, a processor core, or in digital circuitry or analog circuitry, or as a program, software, or firmware, stored in a non-transitory computer readable medium or in another medium, executable by a general purpose computer, a processor, or a processor core. Anything described as “circuitry” could alternatively be implemented as programmable hardware, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
providing, by an application, an operation for execution on an accelerated processing device (“APD”);
selecting a shader program version based on a hardware version for the APD and on the operation provided by the application; and
executing the selected shader program version.

2. The method of claim 1, wherein the operation provided by the application includes a request to execute the shader program.

3. The method of claim 1, wherein the shader program includes an operation to reserve resources, wherein the amount of resources reserved is dependent on the hardware version.

4. The method of claim 3, wherein the shader program includes a task request that specifies parameters based on the hardware version.

5. The method of claim 4, wherein the parameters include bounding volume hierarchy (“BVH”) traversal state.

6. The method of claim 4, wherein the parameters include ray state for a ray for ray tracing.

7. The method of claim 1, further comprising compiling a set of shader program versions including the selected shader program version.

8. The method of claim 7, wherein the compiling includes processing one or more preprocessing directives controlling which resources to reserve.

9. The method of claim 1, wherein executing the selected shader program version results in generating information for rendering an output image.

10. A system comprising:
a first processor configured to execute an application; and
an accelerated processing device (“APD”),
wherein the first processing is configured to:
provide, by an application, an operation for execution on the APD, and
select a shader program version based on a hardware version for the APD and on the operation provided by the application; and
wherein the APD is configured to execute the selected shader program version.

11. The system of claim 10, wherein the operation provided by the application includes a request to execute the shader program.

12. The system of claim 10, wherein the shader program includes an operation to reserve resources, wherein the amount of resources reserved is dependent on the hardware version.

13. The system of claim 12, wherein the shader program includes a task request that specifies parameters based on the hardware version.

14. The system of claim 13, wherein the parameters include bounding volume hierarchy (“BVH”) traversal state.

15. The system of claim 13, wherein the parameters include ray state for a ray for ray tracing.

16. The system of claim 10, wherein the first processor is further configured to compile a set of shader program versions including the selected shader program version.

17. The system of claim 16, wherein the compiling includes processing one or more preprocessing directives controlling which resources to reserve.

18. The system of claim 10, wherein executing the selected shader program version results in generating information for rendering an output image.

19. A non-transitory computer-readable medium storing instructions that, when executed by a processor, cause the processor to perform operations comprising:
providing, by an application, an operation for execution on an accelerated processing device (“APD”);
selecting a shader program version based on a hardware version for the APD and on the operation provided by the application; and
executing the selected shader program version.

20. The non-transitory computer-readable medium of claim 19, wherein the operation provided by the application includes a request to execute the shader program.
